(19) United States
(12) Patent Application Publication
(10) Pub. No.: US 2002/0137420 A1
(43) Pub. Date: Sep. 26, 2002

(54) Absorbent articles

(76) Inventors: Denise Marie Dacey, Flemington, NJ (US); Hans Michael Moscherosch, Doylestown, PA (US); Joseph Michael Luizzi, Newtown, PA (US)

Correspondence Address: AUDLEY A. CIAMPORCERO JR., JOHNSON & JOHNSON, ONE JOHNSON & JOHNSON PLAZA, NEW BRUNSWICK, NJ, 08933-7003, US

(21) Appl. No.: 10/102,086

(22) Filed: Mar. 20, 2002

Related U.S. Application Data
(63) Continuation of application No. 09/537,880, filed on Mar. 29, 2000.

(51) Int. Cl. B32B 5/02; B32B 27/04; B32B 27/12; D04H 1/00; D04H 3/00; D04H 5/00; D04H 13/00; B32B 5/26; B32B 5/06; B32B 5/16

(52) U.S. Cl. 442/389; 442/101; 442/121; 442/148; 442/381; 442/394; 442/417

(57) ABSTRACT

Absorbent articles having a top odor absorbing layer, a middle moisture absorbing layer, and a bottom non-skid layer are disclosed. The bottom non-skid layer has a static coefficient of friction of greater than 1.0 and a dynamic coefficient of friction of greater than 0.9. The articles are particularly useful for disposable shoe inserts.

The present invention relates to absorbent articles. The absorbent articles contain a top odor absorbing layer, a middle moisture absorbing layer, and a bottom non-skid layer. The articles are particularly useful for disposable shoe inserts.

Physiologically, feet are designed to sweat. Closed shoes, because of their design and their materials of construction can exacerbate foot sweat. Warmer weather, physical conditions, medical conditions, and high activity can all increase foot sweat. What often results from foot sweat is a wet environment for the foot and foot odor. Foot odor is embarrassing to the sufferer. In addition, a wet foot environment can aggravate foot maladies such as irritation, itching, and athlete's foot.

Shoe inserts are currently available to address some of the problems associated with foot sweat. The inserts may provide some moisture absorbence, but are mainly known for odor absorbence. Although the inserts are termed disposable, because of their price and construction, these shoe inserts are typically replaced no more than once per month. The shoe inserts are not expected to be efficacious in terms of moisture and odor absorbence over such an extended period of time.

Therefore, there is a need for an improved odor and moisture absorbing shoe insert that is designed and priced for daily replacement.

U.S. Pat. No. 3,852,897 discloses an odor absorbing shoe insock. The insock contains a natural or synthetic fiber web or mat, which has a backing material of paper, cloth, or nylon. The bottom surface of the insock may have a foam layer. Active carbon is utilized as an odor absorber. The active carbon is loaded on the fiber web or mat with a polymeric binder. The reference teaches that the insocks efficiently remove odor and are mechanically sound for two weeks. The issues of improved moisture absorbence and daily replacement were not addrressed.

U.S. Pat. No. 4,158,402 discloses a moisture and odor absorbing shoe insock. The insock contains an upper fabric layer and a lower foam layer. Active carbon is utilized as an odor absorber. The active carbon is loaded in a polymeric binder and is positioned between the upper fabric layer and the lower foam layer. The issues of improved moisture absorbence and daily replacement were not addrressed.

U.S. Pat. No. 4,864,740 discloses a hygienic shoe insole. The insole contains three layers. The upper layer is a spunbonded polypropylene material. The middle layer is a composite layer of pulp fibers and polypropylene fibers meltblown onto the upper layer. The bottom layer is polyethylene vinyl acetate, which is meltblown onto the middle layer. Activated charcoal is taught as a useful odor absorbing agent and is located in the middle layer of the insole. The insoles are taught to be useful for approximately one week. The issues of improved moisture absorbence and daily replacement were not addrressed.

U.S. Pat. No. 4,826,497 discloses fibrous absorbent articles, including shoe inserts, which contain zeolites as odor absorbants. The articles may be unicomponent or multicomponent. The multicomponent articles may have layers. The location of the zeolite in a multicomponent article was not addressed. The issues of improved moisture absorbence and daily replacement were also not addrressed.

U.S. Pat. No. 5,432,000 discloses a fiber product which is coated with a starch binder. Zeolites may be adhered to the fibers through the starch coating. The fibers are taught as being useful in shoe inserts. The location of the zeolite in a multicomponent article was not addressed. The issues of improved moisture absorbence and daily replacement were also not addressed.

Despite the disclosures of the above-references, there is still a need for an improved odor and moisture absorbing shoe insert that is designed and priced for daily replacement.

The present invention provides an article including: a top, or upper, odor absorbing layer, a middle moisture absorbing layer, and a bottom, or lower, non-skid layer having a static coefficient of friction of greater than 1.0 and a dynamic coefficient of friction of greater than 0.9.

The top odor absorbing layer may be a foam, (either an open cell form or a closed cell form, a nonwoven material made from natural manmade fibers, or a combination thereof. The top odor absorbing layer contains an odor absorbing material. Suitable odor absorbing materials include, but are not limited to clay, activated charcoal, chlorophyll, cyclodextrin, ethylenediamine tetraacetic acid, sepiolite, and zeolite. The preferred odor absorbing material is zeolite. The amount of odor absorbing material in the top odor absorbing layer may range from 1 percent by weight to 75 percent by weight, preferably from 10 percent by weight to 50 percent by weight, more preferably from 20 percent by weight to 40 percent by weight, based on the total weight of the top odor absorbing layer. Preferably, the top odor absorbing layer is a nonwoven material comprising natural and/or manmade fibers which are chemically bonded (e.g., with a polymeric binder) and contain zeolite. Chemically bonded natural and manmade fiber nonwoven materials containing zeolites are commercially available through BFF Nonwovens as Zeovate® products. A particularly useful product is Zeovate® SVZ 80.

The middle moisture absorbing layer may be made from any moisture absorbing material, including, but not limited to natural and manmade fiber nonwoven materials, peat moss, cellulosic fiber materials such as paper, cotton, and flannelette, superabsorbent polymers such as the cross-linked sodium salt of polyacrylic acid, polyvinyl pyrrolidone, polyamide, polyvinyl alcohol, and carboxymethyl cellulose, and absorbent foams such as Hypol* polyurethane foam (B. F. Goodrich) or other polyurethane foams. In a preferred embodiment, the middle moisture absorbing layer is selected from the group consisting of chemically bonded pulp, thermally bonded pulp, and combinations thereof. The pulp may be wetlaid, airlaid, or a combination thereof.

The bottom non-skid layer may be made from any suitable polymeric material having a static coefficient of friction (“COF”) of greater than 1.0 and a dynamic COF of greater than 0.9, both as measured according to ASTM D-1894. The bottom non-skid layer has a glass transition temperature (Tg) less than −15° C. The Tg is the temperature at which the maximum loss tangent (Tan δ or G″/G′) occurs when dynamic modulus is measured as a function of temperature using a dynamic analyzer, such as the Rheometrics RDAII (Rheometrics Inc., Piscataway, N.J.). The bottom non-skid layer also has a shear storage modulus, (G′), in the application temperature use range of from −40° C. to 50° C., of greater than 1×10⁵ dynes/cm².

In conjunction with the fact that the bottom non-skid layer has a shear storage modulus, (G′), of greater than 1×10⁵ dynes/cm², the bottom non-skid layer has little or no pressure sensitive tack. This combination of high COF and shear storage modulus, and low Tg and tack provide a bottom non-skid layer that conforms well to the area where it is applied, exhibits little or no shifting or bunching during use, and is readily removable for disposal. Suitable materials to make the bottom non-skid layer are commercially available and include, but are not limited to hot-melt adhesive 195-338 from ATO-Findley, and Easy Melt 34-3396 from National Starch and Chemical. The adhesives may be applied as hot melt coatings.

In one embodiment of the present invention, the adhesive may be applied using a hot melt foam adhesive applicator such as the FoamMelt® or FoamMix® from Nordson Corp., Amherst, Ohio. When applied in this manner, the adhesive becomes a foamed structure, having reduced density. By utilizing this technology, density reductions of 32% have been achieved. The reduced density allows the use of less raw material for a given thickness of the bottom non-skid layer. Bottom non-skid layers made by this technique have a resilient foamed structure and provide added cushioning during use.

The bottom non-skid layer functions to keep the absorbent article well in place without wrinkling and without leaving residue upon removal from the area where it is applied. The bottom non-skid layer may cover the entire bottom surface of the absorbent article, or may cover only certain regions or sections of the bottom surface of the absorbent article. The consumer can repeatedly adjust the absorbent article upon insertion into the area where it is to be used and yet stay well in place when in use. For example, a consumer may insert the absorbent article in a shoe and adjust the position of the absorbent article several times, yet the absorbent article, when finally placed, will stay in place without wrinkling.

The three layers of the absorbent article may be bonded through the use of conventional, commercially available adhesives. The adhesives may be made by any polymerization process including solution or dispersion processes. The adhesives may be hot melt adhesives.

Examples of suitable adhesives include, but are not limited to, those based on styrenic block copolymers and tackifying resins such as HL-1491 from HB-Fuller Co. (St. Paul, Minn.), H-2543 from ATO-Findley (Wawatausa, Wis.); and Easy Melt 34-5534 from National Starch & Chemical Company (Bridgewater, N.J.). Ethylene copolymers including ethylene vinyl acetate copolymers, may also be used. Other suitable adhesives include acrylic based, dextrin based, and urethane based adhesives as well as natural and synthetic elastomers. The adhesives may also include amorphous polyolefins, including amorphous polypropylene, such as HL-1308 from HB Fuller or Rextac RT 2373 from Huntsman (Odessa, Tex.).

The top, odor absorbing layer may be bonded to the middle moisture absorbing layer by methods such as thermal bonding, mechanical bonding, and ultrasonic bonding. In a preferred embodiment, the top odor absorbing layer and the middle moisture absorbing layer are laminated together via an adhesive or ultrasonic bonding sheet.

When bonding the top odor absorbing layer to the middle moisture absorbing layer, the amount of adhesive will typically range from 2 milligrams per square inch to 20 milligrams per square inch, preferably from 3 milligrams per square inch to 12 milligrams per square inch. When bonding the middle moisture absorbing layer to the bottom non-skid layer, the amount of adhesive will typically range from 20 milligrams per square inch to 350 milligrams per square inch, preferably from 30 milligrams per square inch to 100 milligrams per square inch.

Fragrance, powders or other actives including anti-microbial agents can, if desired, be added to either or both the top odor absorbing layer and the middle moisture absorbing layer. The amount of these materials may range from 0 to 50 percent, preferably from 1 percent to 10 percent by weight, based on the basis weight of the layer in question.

The absorbent article may additionally contain a material that aids in stiffening the article and preventing bunching. For this purpose, the absorbent article may be coated with a stiffening agent such as, but not limited to, starch, paper, and paper-pulp products. Alternatively, for this purpose, the absorbent article may contain an additional layer such as, but not limited to, a polymeric film having a thickness ranging from about 0.005 mm to 0.1 mm. Examples of suitable polymeric films include, but are not limited to, polyethylene, polypropylene, and polyurethane. Preferably, this additional layer would be placed between the top layer and the middle layer.

In one embodiment of the present invention, the moisture absorbent article is a shoe liner. The process for making shoe liners may be a continuous roll web laminating process. In the process, adhesive is applied to the lower surface of the top, odor absorbing layer. The middle moisture absorbing layer is then bonded to the top, odor absorbing layer by bringing the lower, adhesive coated surface of the upper, odor absorbing layer into sealing contact with the upper surface of the middle moisture absorbing layer. The bottom non-skid layer may then be slot coated onto the middle, moisture absorbent layer to complete the multi-layer construction. Active ingredients and fragrances can be added at any of several different stations along the manufacturing line. The resulting multi-layer construction, i.e., laminate, may be manufactured in wide rolls that are subsequently slit into multiple rolls of desired width, embossed, and, if desired, printed, e.g., with a decorative pattern. The laminated structure may then be folded in half, non-skid layer sides together, along the machine direction and then die-cut to produce pairs of left-foot and right-foot-shaped inserts. The shoe-shaped pairs are finally stacked for packaging. The physical dimensions of the shoe inserts are designed to match those of standard shoe sizes. The thickness of the shoe insert may range from 0.25 millimeters to 5.0 millimeters, preferably from 0.50 millimeters to 2.0 millimeters, more preferably from 0.70 millimeters to 1.0 millimeters.

The shoe liner may be designed such that it can be worn in either the user's left or right shoe. This is accomplished by making the liner symmetrical from the arch back to the heel as well as from the arch to the toe.

When the absorbent article is to be marketed as a shoe liner, a generally rectangular piece of the absorbent article may comprise perorations in the shape of a shoe. The end user can then separate the shoe liner from the remainder of the rectangular piece by pressing the absorbent article along those perforations. Additionally, a generally rectangular piece of the absorbent article of the invention may comprise a plurality of concentrically disposed, shoe-shaped regions, each defined by its own set of perforations. The end user would thus be provided with a selection of various sized shoe inserts.

### BRIEF DESCRIPTION OF THE DRAWINGS

FIG. 1 is a perspective view, with a portion turned upwardly, of a first embodiment of an absorbent article in accordance with the present invention;

FIG. 2 is a cross-section, greatly enlarged in thickness, taken along line 2-2 of FIG. 1;

FIG. 3 is an exploded perspective showing the major components of the absorbent article of FIG. 1;

FIG. 4 is a fragmentary, cross-sectional view of absorbent article 10 in which the top, odor absorbing layer is secured to the middle, moisture absorbing layer of adhesive;

FIG. 5 is a fragmentary perspective of a second embodiment of an absorbent article in accordance with the invention in which the material forming the non-skid layer is applied to the lower surface of the middle layer in a plurality of discrete regions;

FIG. 6 is a cross-sectional view, greatly enlarged, of the absorbent article of FIG. 5; and

FIGS. 7-10 are top plan views which illustrate other patterns in which the material comprising the bottom, non-skid layer may be applied to the lower surface of middle layer 16.

The following examples are intended to demonstrate the absorbent articles and the process of preparing shoe liners of this invention. The examples should not be construed as limiting the scope of the invention.

### EXAMPLE 1

### Preparation of Absorbent Article

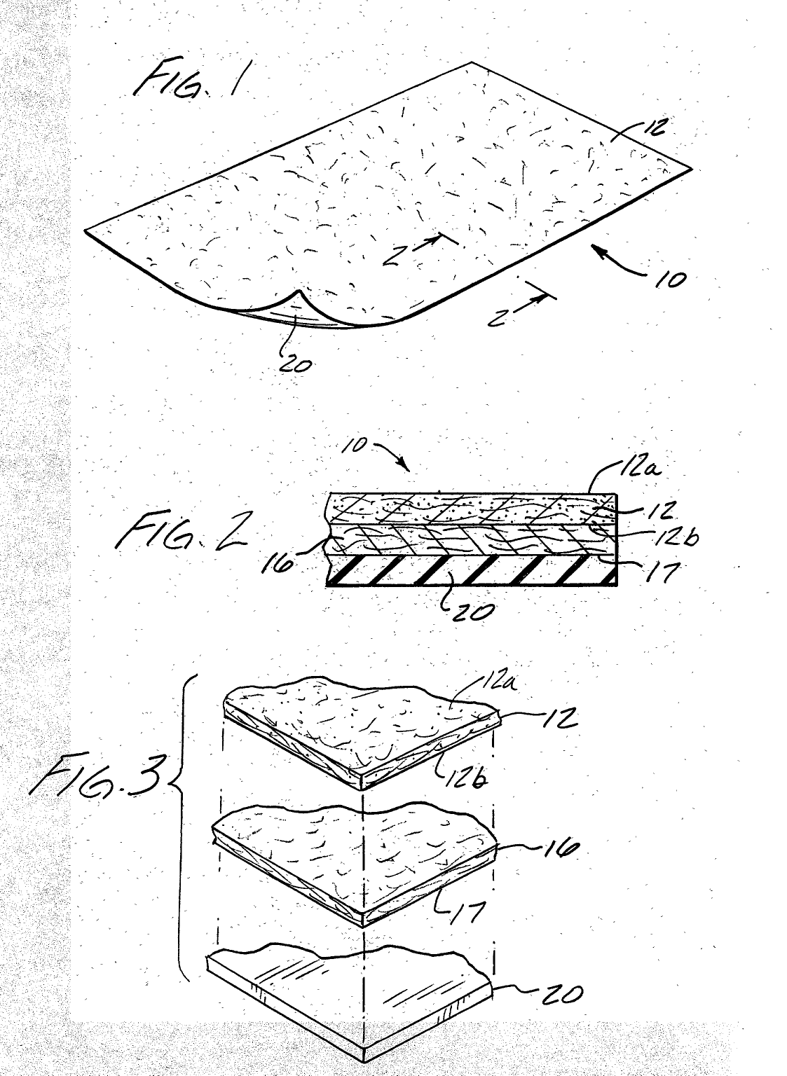

Referring to FIGS. 1 and 2 of the accompanying drawings, a first embodiment of an absorbent article 10 in accordance with the teachings of the present invention is a multi-layer laminate which comprises a top, or upper, odor absorbing layer 12; a middle, moisture absorbing layer 16; and a bottom, or lower, non-skid layer 20.

Odor absorbing layer 12 is a nonwoven fabric comprising viscose rayon fibers and naturally occuring zeolites.

This nonwoven fabric, which is commercially available from BFF Nonwovens, Bridgewater, Someret IM, England, under the designation Zeovate® SVZ80, has a basis weight of approximatley 80 grams per square meter. It contains approximately 34% zeolites based on the total weight of the nonwoven fabric. The nonwoven fabric has a thickness of about 0.3 mm.

Middle, moisture absorbing layer 16 is a nonwoven fabric comprising air-laid cellulosic pulp bonded with a polymeric binder. This air-laid nonwoven fabric, which is available commercially from Fort James, Green Bay, Wis., US under the designation Airtex® Grade 338, has a basis weight of about 60 grams per square meter. It has a MD tensile strength of about 1.6 Newtons (N) per 5 cm fabric width, a CD of about 1.4 Newtons per 5 cm fabric width, and a thickness of about 0.54 mm. This fabric has an absorbent capacity of about 13 grams of water per gram of fabric as determined by modified ASTM 4032-82 (501b).

Bottom, non-skid layer 20 is made from a non-pressure sensitive hot melt adhesive which is available from Ato Findley, Wauwatosa, Wis., US, under the designation 195-338. This is a polyarylene polyalkene block copolymer whose elastic modulus at 25° C. is 3.3×10⁷ dynes/cm².

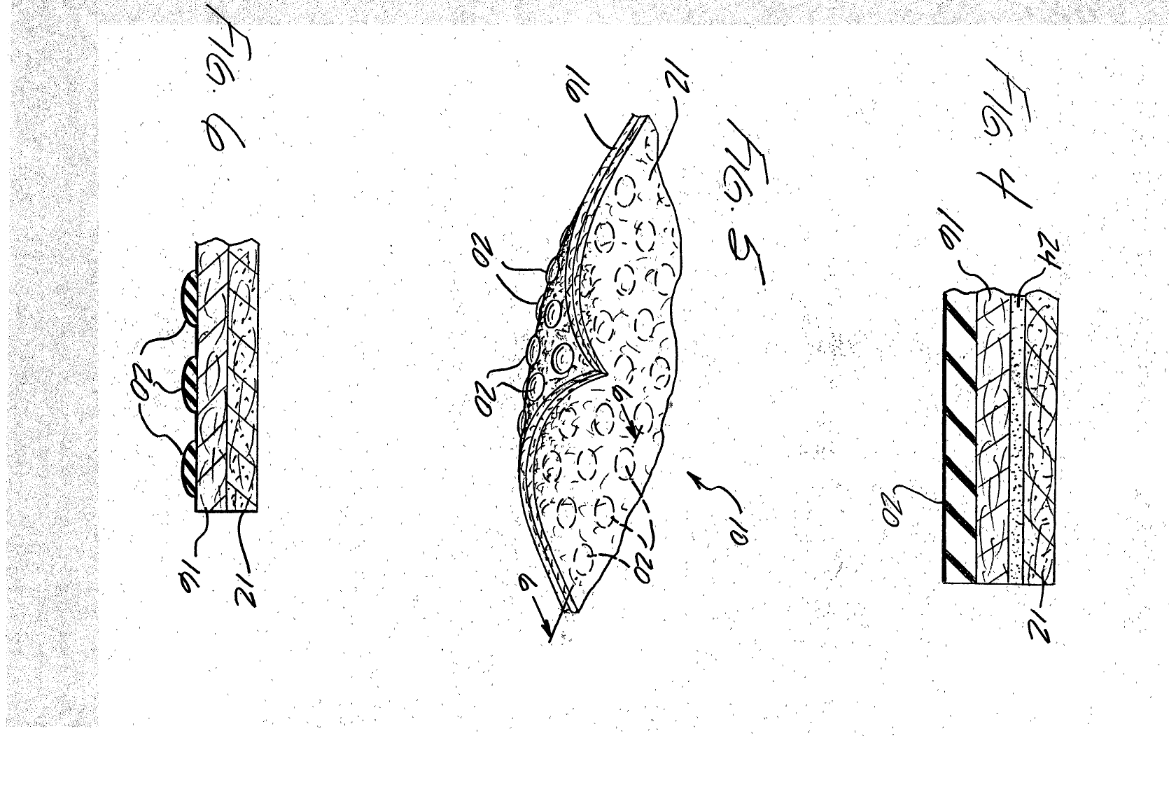

Absorbent article 10 is made as follows: The above-described odor absorbing layer 12 (i.e., Zeovate® SVZ 80) is unwound from its supply roll and spray-coated on its lower surface 12b with H. B. Fuller (St. Paul, Minn., USA) adhesive HL-1491, designated by numeral 24 in FIG. 4.

The adhesive was applied at a temperature of about 270° F. and at a rate of about 8 grams per square meter. The above described moisture absorbing layer (i.e., Airtex® Grade 338 nonwoven fabric) was then brought into contact with the adhesive coated surface 12b of odor-absorbing layer 12, the temperature of the adhesive being held at about 270° F. during this time.

The bottom surface 17 of moisture absorbing layer 16 was then slot-coated with the above-mentioned nonpressure sensitive hot melt adhesive (i.e., Ato Findley Adhesive #195-338) at a coating rate of about 55 grams per square meter to provide a continuous nonskid layer 20. This slot-coating process was performed at approximately 300° F.

If the absorbent article 10, made as described immediately above, is to be used as a shoe liner, it is preferable, though not necessary, to emboss the upper surface 12a of the absorbent article. The embossing can be carried out in known fashion using a nonheated embossing roller against a hard rubber anvil roll. Conveniently, the embossing roller has a pattern of staggered axial rows of embossing pins in which the center-to-center axial distance between adjacent pins is 6.35 mm and the circumferential distance between adjacent rows of embossing pins is about 3.2 mm. The top of the embossing pins are flat, are circular in configuration and have a diameter of about 0.9 mm.

It will be apparent to those skilled in the art that the embossing step may be done with any one of a large variety of well-known embossing patterns.

The absorbent article, either unembossed or embossed as described above, can be easily die cut into the shape of shoe liners.

### EXAMPLE 2

### Absorbency Testing

The absorbent article prepared above was tested against various commercial products for absorbency using a modified ASTM 4032-82 (501b). The absorbent article (a 37.5 millimeter×37.5 millimeter sample) was weighed, then placed top odor absorbing layer side down into a 1 percent saline solution. The article was soaked in the solution for 1 minute. The article was then removed and hung vertically using a binder clip holding one small corner of the article. The article was hung for 2 minutes, then weighed. The difference in dry weight compared to wet weight is the capacity. Samples of Johnson's Odor Eaters for Work Boots, Johnson's Odor Eater Sneaker Tamers, Johnson's Odor Eaters Ultra Comfort, Dr. Scholls Odor Destroyers All Purpose, Dr. Scholls Air-pillo Cushioning Comfort Insole, and Equate Comfort Cushion Foam Insoles were also tested. The results are reported in Table 1.

TABLE 1

Weight, grams

| Sample | Before | After | Capacity* |
|---|---|---|---|
| Example 1 (invention) | 0.29 | 1.30 | 1.01 |
| Johnson's Odor Eaters for | 1.50 | 1.98 | 0.48 |
| Work Boots | | | |
| Johnson's Odor Eater Sneaker | 1.17 | 1.70 | 0.53 |
| Tamers | | | |
| Johnson's Odor Eaters Ultra | 1.01 | 1.69 | 0.68 |
| Comfort | | | |
| Dr. Scholls Odor Destroyers | 1.38 | 1.54 | 0.16 |
| All Purpose | | | |
| Dr. Scholls Air-pillo | 1.02 | 1.08 | 0.06 |
| Equate Comfort Cushion | 1.06 | 1.13 | 0.07 |
| Foam Insoles | | | |

*in grams

Table 1

The data above demonstrates that the absorbent article of the present invention absorbs significantly more moisture than absorbent articles known in the art.

### EXAMPLE 3

### Comfort Testing

The shoe liners prepared in Example 1 above were tested for comfort. The shoe liners were placed inside shoes and worn for 8 hours. They were found to be comfortable. No wrinkles formed in the shoe liners. The shoe liners remained in place during use, yet were easily removed after use, without leaving residue in the shoe. No foot odor was noted in the shoes.

As indicated earlier herein, non-skid layer 20 may be provided as a continuous layer on the lower surface of moisture-absorbing layer 6 or it can be provided in a pattern in which only certain regions of layer 16 are covered.

In FIGS. 5 and 6, non-skid layer 20 is applied in a series of circular dots.

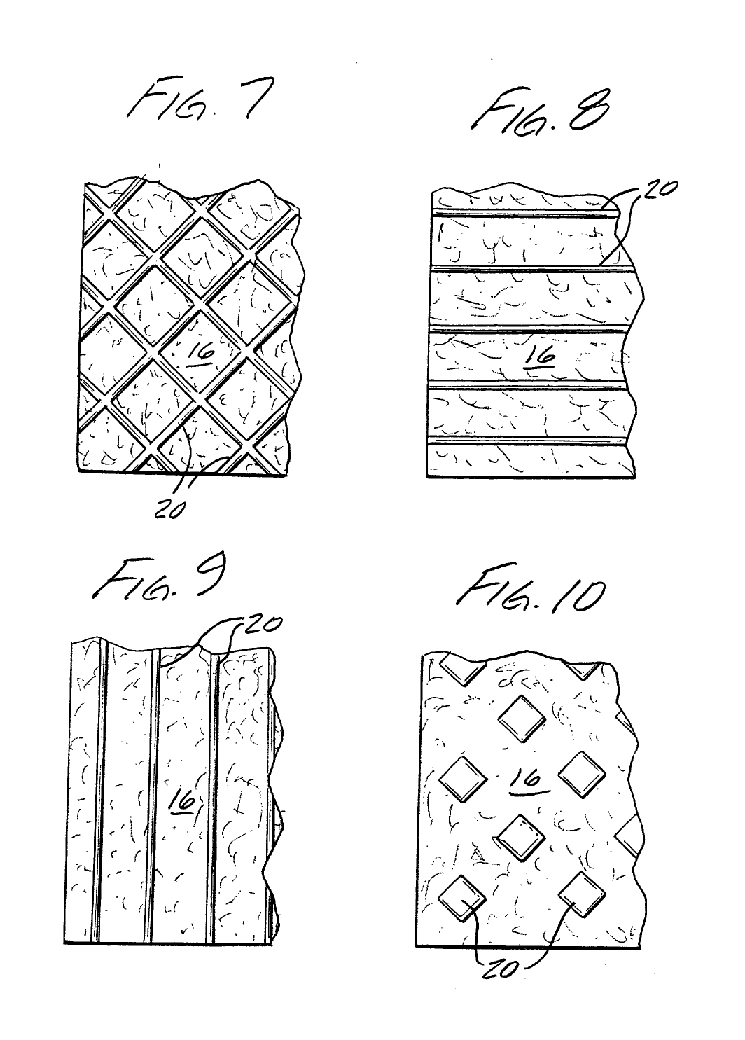

In FIG. 7, the non-skid material 20 is applied in a pattern of intersecting lines.

In FIG. 8, the non-skid material 20 has been applied in a pattern of vertically spaced, horizontally extending ribs, while in FIG. 9 the non-skid material has been applied in a pattern of horizontally spaced, vertically extending ribs.

In FIG. 10, the non-skid material 20 has been applied in the form of a plurality of diamonds in a staggered pattern.

We claim:

1. An article comprising:
a top odor absorbing layer,
a middle moisture absorbing layer, and
a bottom non-skid layer having a static coefficient of friction of greater than 1.0 and a dynamic coefficient of friction of greater than 0.9.

2. The article of claim 1, wherein the top odor absorbing layer comprises a nonwoven material selected from natural and manmade fibers containing an odor absorbing material selected from the group consisting of clay, activated charcoal, chlorophyll, cyclodextrin, ethylenediamine tetraacetic acid, sepiolite, and zeolite.

3. The article of claim 2, wherein the top odor absorbing layer is a nonwoven material selected from natural and manmade fibers which are chemically bonded and contain zeolite.

4. The article of claim 1, wherein the middle moisture absorbing layer comprises a moisture absorbing material selected from the group consisting of natural and manmade fiber nonwoven materials, peat moss, cellulosic fiber materials selected from paper, cotton, and flannelette, superabsorbant polymers selected from the sodium salts of polyacrylic acid, polyvinyl pyrrolidone, polyamide, polyvinyl alcohol, and carboxymethyl cellulose, and absorbant foams.

5. The article of claim 4, wherein the middle moisture absorbing layer is selected from the group consisting of chemically bonded airlaid pulp material, thermally bonded airlaid pulp material, and combinations thereof.

6. The article of claim 1, wherein the bottom non-skid layer is made from a polymeric material.

7. The article of claim 6, wherein the polymeric material is an adhesive.

8. The article of claim 7, wherein the adhesive is applied using a hot melt foam adhesive applicator.

9. A moisture and odor absorbing article comprising:
a top odor absorbing layer comprising a nonwoven material selected from natural and manmade fibers which are chemically bonded and contain zeolite;
a middle moisture absorbing layer comprising a moisture absorbing material selected from the group consisting of chemically bonded airlaid pulp material, thermally bonded airlaid pulp material, and combinations thereof; and
a bottom non-skid layer comprising an adhesive having a static coefficient of friction of greater than 1.0 and a dynamic coefficient of friction of greater than 0.9;
wherein the bottom non-skid layer is applied using a hot melt foam adhesive applicator.

10. The article according to claim 9, wherein the article is a shoe liner.

11. A process comprising:
preparing an absorbent article by applying adhesive to a top odor absorbing layer;
bonding a middle moisture absorbing layer to the top odor absorbing layer; and
applying a bottom non-skid layer having a static coefficient of friction of greater than 1.0 and a dynamic coefficient of friction of greater than 0.9 onto the middle moisture absorbent layer;
folding the absorbent article in half, non-skid layer sides together; and
die-cutting the absorbent article; wherein the absorbent article is a shoe liner and the shoe liner is symmetrically shaped from the arch back to the heel as well as from the arch to the toes.

12. The process according to claim 11, wherein:
the top odor absorbing layer is a nonwoven material selected from natural and manmade fibers which are chemically bonded and contain zeolite;
the middle moisture absorbing layer is selected from the group consisting of chemically bonded airlaid pulp material, thermally bonded airlaid pulp material, and combinations thereof; and
the bottom non-skid layer is an adhesive;
wherein the bottom non-skid layer is applied using a hot melt foam adhesive applicator.
